(19) United States
(12) Patent Application Publication
(10) Pub. No.: US 2020/0118204 A1
(43) Pub. Date: Apr. 16, 2020

(54) METHOD FOR EFFECTING FINANCIAL TRANSACTIONS

(71) Applicant: SONECT AG, Brüttisellen (CH)

(72) Inventors: Sandipan CHAKRABORTY, Brüttisellen (CH); Sebastian BÜRGEL, Frick (CH)

(73) Assignee: SONECT AG, Brüttisellen (CH)

(21) Appl. No.: 16/603,693

(22) PCT Filed: Oct. 10, 2018
(86) PCT No.: PCT/EP2018/059140

§ 371 Date: Oct. 8, 2019

(30) Foreign Application Priority Data
Apr. 10, 2017 (CH) 00478/17

(51) Int. Cl. G06Q 40/02; G06Q 40/04; G06Q 20/40; G06Q 20/10; G06Q 20/32; H04L 9/06

(52) U.S. Cl. CPC G06Q 40/02; G06Q 40/04; G06Q 20/405; H04L 2209/38; G06Q 20/3224; H04L 9/0637; G06Q 20/1085

(57) ABSTRACT

In a method for effecting financial transactions a first party obtains cash from a second party. At least one first time-location pair relating to the first party is determined, based on data accessible by an application running on a mobile device of the first party. Second time-location pairs relating to a plurality of candidates for the second party are determined. The result of a comparison of the at least one first time-location pair with the second time-location pairs is displayed on the mobile device of the first party. One of the plurality of candidates to determine the second party is chosen, and cash is transferred from the second party to the first party. The second party serves as a “virtual” ATM. This allows for using the method for cash withdrawals from local merchants such as bakeries, kiosks, bars or other shops or even from private people. This is very convenient for the customers, and merchants may reduce their costs for securely handling and storing considerable amounts of cash. Finally, banks do not need to set up and maintain a large number of ATMs. Due to the assessment of candidates based on time-location pairs the first party wishing to withdraw cash will easily find a convenient nearby virtual ATM.

### TECHNICAL FIELD

The invention relates to a method for effecting financial transactions, wherein a first party obtains cash from a second party.

### BACKGROUND ART

Today, cash money is usually obtained from automated teller machines (ATMs). They are convenient and often available at any time.

Nevertheless, todays ATMs have some drawbacks. First of all, an ATM is not available everywhere, and if an ATM is out of order the next machine might be far away. ATMs involve security risks such as the danger of card “skimming” (where a third party illegally obtains card information during an ATM transaction and uses it to withdraw money). Furthermore, most ATMs provide a possibility to withdraw cash but no possibility to deposit cash. Accordingly, people or businesses that are in possession of an excessive amount of cash need to go to a bank counter or to a distant specific ATM that allows for deposits.

Accordingly, there is a need for further possibilities to obtain or deposit cash. Methods have been proposed that allow for the withdrawal of cash at the point-of-sale of a business, e. g. a store. Further methods have been proposed that allow for peer-to-peer withdrawal/deposit of cash, e. g. using mobile phones.

However, the known methods usually lack simplicity for the users and require some planning on the part of the users in order to be able to do their transactions.

### SUMMARY OF THE INVENTION

Accordingly, it is the object of the invention to create a method for effecting financial transactions, wherein a first party obtains cash from a second party that are easy to use and reduce the efforts on the part of the users.

The solution of the invention is specified by the features of claim 1. According to the invention the method comprises the steps of:
a) determining at least one first time-location pair relating to the first party, based on data accessible by an application running on a mobile device of the first party;
b) determining second time-location pairs relating to a plurality of candidates for the second party;
c) displaying a result of a comparison of the at least one first time-location pair with the second time-location pairs on the mobile device of the first party;
d) choosing one of the plurality of candidates to determine the second party;
e) transferring cash from the second party to the first party.

In the simplest case, a “time-location pair” refers to the current time and position of the first party or a candidate for the second party, respectively. As described in more detail below, a time-location pair may also refer to a future point in time and a corresponding position. Generally, it will indicate a measured or expected location of the first party or a candidate at a given (present or future) point in time.

It is to be noted that “displaying” includes not only visual display on a screen of the mobile device but also e. g. acoustic feedback.

According to the inventive method, the second party serves as a “virtual” ATM. This allows for using the inventive system for cash withdrawals from local merchants such as bakeries, kiosks, bars or other shops or even from private people. This is very convenient for the customers, and merchants may reduce their costs for securely handling and storing considerable amounts of cash. Finally, banks do not need to set up and maintain a large number of ATMs.

Due to the assessment of candidates based on time-location pairs the user wishing to withdraw cash will easily find a convenient nearby virtual ATM.

Users (candidates for second party) have the ability to enable and to disable the virtual ATM service as they like and in accordance with their cash reserves. Preferably, users that have disabled the virtual ATM service at the relevant point in time will not serve as candidates.

Preferably, the at least one first time-location pair is obtained from a navigation service integrated in the mobile device of the first party. Most of today's mobile devices such as smartphones or tables include a navigation service, e. g. GPS and/or WiFi based. Accordingly, it is easy and convenient to obtain the current location of the first party by using this service.

Such a service may also be used to obtain the current location of candidates for the second party, if they are equipped with a mobile device as well (e. g. private people that are ready to serve as virtual ATMs).

Alternatively, other means of obtaining the location of the first party may be used, e. g. requesting the user to enter a current address, using local beacons etc. The same applies to the location of the second party. In the case of stationary second parties (such as stores) the location (such as an address or (GPS) coordinates) may be simply entered in a setup menu.

In a preferred embodiment of the invention, the at least one first time-location pair is obtained from a calendar accessible via the mobile device of the first party, in particular by the application running on the mobile device of the first party. Today's calendar applications usually offer the possibility to enter not only the time of an event as well as an event description but also the location of an event (e. g. in the form of an address). Accordingly, based on the calendar one may deduce future locations of the first party.

Similarly, future locations of candidates for the second party may as well be determined from calendar entries. As an example, one might find out that the first party and a candidate for the second party attend the same meeting, have an appointment at the same hair dresser at the same time, plan to go to the same bar after work etc. If the candidate is stationary, e. g. a business like a restaurant, bar, shop etc., one may find out based on the calendar if the first party plans to visit the respective premises at a certain point in time.

In a further preferred embodiment of the invention, the at least one time-location pair and/or at least one of the second time location pairs is obtained from an order or reservation accessible by the application running on the mobile device of the first party.

Similar to calendar entries, orders or reservations, such as orders for pizza delivery, the delivery of goods, dinner table reservations, hair dresser appointments, etc. provide information on a future location of two parties (the first party and the counterpart—e. g. the delivery person, the restaurant, the hair dresser's shop, etc.).

The order or reservation may be directly accessible by the application running on the mobile device of the first party if it is already stored on this device. It may also be provided to the application indirectly, such as by the party the order or reservation refers to or by a service provider providing the virtual ATM service to the first and second party. Corresponding information may also be provided by online services such as parcel or mail tracking applications, table reservation services, etc.

Accordingly, the at least one time-location pair and at least one of the second time location pairs may relate to a future point in time. In this case, even if presently no virtual ATM is nearby, the inventive method will find out that there will be a good opportunity for cash withdrawal at a later point in time, e. g. during lunch in a restaurant or in the context of pizza delivery, later the same day. This greatly enhances the convenience for the users and reduces the total time required to do a cash withdrawal.

In a preferred embodiment, the mobile device of the first party runs an application being in contact with a server or a decentralized block chain based system, and a mobile device of the second party runs an application being in contact with the same server or block chain based system. Accordingly, the entire virtual ATM service may be based on mobile devices essentially running the same app. In principle, every participant may serve as a first party (withdrawing cash) or a second party (providing cash), depending on the respective amount of available cash. As an example, the application offers the possibility of choosing between one of the three states:

A) needing money (withdrawal desired);

B) providing money (excess amount available);

C) service currently disabled (cash neither required nor available).

Preferably, in this case the choice of the second party of a certain virtual ATM is submitted from the mobile device of the first party to the server or block chain based system and from there to the mobile device of the second party to generate a message displayed on the mobile device of the second party. This allows for quickly connecting the two parties such that they will be able to do the transaction.

Alternatively, one of the parties interacts with the system in another way, such as virtual ATMs in businesses being provided by desktop computers or cash desks. Furthermore, the method may be implemented without a central server, and the two mobile devices may interact directly (in particular internet-based).

Preferably, a user affinity of the first party is compared with recorded properties of the candidates of the second party in order to obtain a rating with respect to the candidates, and the result of the comparison displayed on the mobile device of the first party includes the rating.

The user affinity is not restricted to time-location pairs but includes other preferences of the user, e. g. with respect to specific service providers used by the first person, specific interests, places that are regularly visited, etc. Taking into account this information, in addition to the time-location data, allows for specifically recommending candidates for the second party that are accepted by the first party. This improves the user experience for the first party and facilitates the match-making between first and second party.

The result of the comparison displayed on the mobile device may be filtered according to the rating, i. e. only a certain number of top rated candidate second parties are displayed. The rating itself or the order of the candidates may be optionally displayed. Optionally, the candidates may be classified according to the rating and displayed in a different way (e. g. using different symbol sizes or colors).

Preferably, a collaborative filtering algorithm is applied to generate a recommendation based on the user affinity and the recorded properties. The efficiency of such approaches is known from recommender systems. They do not require explicit input of preferences by the first user, but provide a systematic framework for the integration of user preference information present within the system.

Advantageously, a latent factor model is used for modelling the user affinity and recorded properties. In a latent factor model, a user is modelled as a vector describing his or her affinity to latent factors. Candidates are modelled as vectors defined by the degree to which they possess each of the latent factors. Latent factor models have been shown to outperform memory based counterparts, in terms of Quality of Prediction (QoP) and coverage. A suitable approach is described in A. Gogna, A. Majumdar: “Blind Compressive Sensing Framework for Collaborative Filtering”, arXiv:1505.01621 [cs.IR].

The time-location pairs may be included in the latent factor model or treated separately as a condition (pre- or post-filtering) and/or order criteria.

Preferably, the user affinity includes information on past actions and/or preferences of the first party. This information may be used in the context of collaborative filtering or taken into account in another way. The information may be recorded by the application providing the virtual ATM functionality to the first user or by other means (such as tracking apps, past calendar events, etc.).

In alternative embodiments, only the time-location information (present and/or future) is used for matching first and second parties.

Preferably, the user affinity of the first party is derived from a history of previous transactions of the first party. In particular, the previous transactions are financial transactions (such as payments) of the first party with shops or service providers such as restaurants, hairdressers, laundries, etc. The affinity (or affinities) of the first party may be obtained from the history of transactions using machine learning and data analytics. As an example, neural networks may be employed, the input layer including variables such as a user ID, position and time of day, the middle nodes containing weights and biases defined by a regression model, wherein the output is a “best match” recommendation for a virtual ATM.

History data relating to more recent transactions may be taken into account with a higher weight than data relating to older transactions.

The history of transactions may include transactions effected using the present inventive method for effecting financial transactions and/or transactions effected using other means.

In particular, the history of previous transactions is advantageously obtained from a financial service provider of the first party via a software interface. Such information may be obtained by the provider of the inventive service, acting inter alia as an Account Information Service Provider (AISP), provided there is consent by the first party, as this is foreseen in the Payment Services Directive 2 (PSD2)—Directive (EU) 2015/2366.

Displaying candidates that match the user's affinities (with respect to the acquisition of goods or services) increases the upselling opportunities of the chosen second party.

Different ways of informing the first party of an opportunity for cash withdrawal exist:
a) as mentioned, the user may obtain a list or map of present or future occasions on request, by using the respective mobile application;
b) the user may receive a (push-type) alert on his or her mobile phone if an occasion is detected, in particular if the occasion allows for a quick transaction;
c) the user is notified in the context of a transaction with a third party such as an order or reservation, in particular there is a further option of cash withdrawal in the context of a delivery or appointment that may be chosen by the user.

Furthermore, the user may be informed at the point-of-sale in the context of a usual payment transaction.

Preferably, the following steps are carried out in order to effect the financial transaction between the first party and the second party:
a) receiving a transaction request from the first party including an identification of the second party and a transaction amount;
b) initiating a first fiat money payment from a bank account of the first party to a pass-through bank account of a service provider;
c) adding an amount of electronic currency corresponding to the fiat money payment to a first e-money account assigned to the first party;
d) authenticating the first party vis-a-vis the second party; and
e) transferring the amount of electronic currency to a second e-money account assigned to the second party.

It is not required that the steps are performed in the indicated order. In particular, authentication of the first party may happen before initiating any fiat or e-money transfer. In certain cases, when there is a sufficient amount of electronic currency on the first e-money account, steps b) and c) may be omitted.

Preferably, the first fiat money payment is initiated by accessing an API of a bank handling the bank account of the first party. The API interface may access a central server or it may be decentralized via a block chain.

On Nov. 25, 2015, the Directive on Payment Services in the Internal Market II (PSD II; Directive 2015/2366) was adopted by the European Parliament and will enter into force on Jan. 13, 2018. A major aspect of PSD II is the right for licensed third-party payment services providers (TPPs) to access payment accounts of customers having given explicit consent to the access. The bank maintaining the customer's payment account must grant TPPs access to account information of specific customers. The banks are required to provide an application programming interface (API) in its IT systems to enable the access by TPPs. This will substantially facilitate the implementation of the inventive system and allow for a quick and wide distribution of the system.

Basically, in the context of the inventive system, the first party (e. g. a consumer) pays directly from its bank account to the bank account of the second party (e. g. a merchant). Every time electronic currency (e-money, tokens) is issued corresponding fiat money is transferred “immediately” to the pass-through account by debiting consumer's account. Merchant's bank has the possibility of simply claiming the book money (anytime) from the pass-through account by exchanging the electronic currency (tokens).

Due to the immediate conversion of fiat money into electronic currency and back the assets of the first and the second party are always secured, either by fiat money or electronic currency owned by the respective party.

High network costs of existing payment rails are avoided, in particular in respect of payments of small amounts (micro payments). High collateral requirements are avoided as well as exchange of information means exchange of value. The number of players is reduced, and therefore the costs (and the fees to be borne by the users of the system) may be reduced.

Preferably, a second fiat money payment is initiated from the pass-through bank account of the service provider to a bank account of the second party, the amount corresponding to the amount of electronic currency and debiting the amount from the second e-money account. Accordingly, it is advantageous if the system comprises a second conversion module for transferring a fiat money amount from the temporary bank account to a bank account of the second party and for debiting a corresponding amount of electronic currency from the second e-money account.

Alternatively, the money stored in the system is kept flowing, i. e. the e-money held by the second party may be circulated further within the system and eventually passed to a third party.

Preferably, the first and second e-money account are based on a block chain, i. e. these accounts are associated with a block chain for the secured recordal of the electronic currency transactions. This provides inherent security of the transactions provided by private/public key signatures, proven to secure billion dollar transactions in public networks. Block chains provide maximum availability as only a fraction of the nodes need to be available at all times to allow for continuous service, therefore the ledger of transactions inside the block chain does not provide a single point of failure. Block chain systems are horizontally scalable (by adding further nodes), which allows for data replication and highly scalable read operations. There is integrated automated fail-over as a core-consensus algorithm ensures that all nodes in a network are always in sync.

The inventive system and method may be based on a public as well as on a private block chain.

Preferably, the block chain is part of a smart contract system and issuance of electronic currency is restricted to a group of registered issuers. Thus it may be ensured that currency used within the system and method is issued by banks and financial intermediaries that comply with regulations in the affected jurisdictions. Accordingly, the system may be based on block chains where the creation of electronic currency is not restricted to a small number of issuers known ab initio (such as banks or central banks).

In a preferred embodiment, the system comprises a first app interface for interaction with a first application running on a device of the first party and by a second app interface for interaction with a second application running on a device of the second party. The authentication module generates authentication information to be sent to the first application by the first app interface, and the transfer module generates a transfer confirmation to be sent to the second application by the second app interface.

The applications may be running on mobile devices (such as smartphones or tablets of the first and/or second party), on general-purpose computer systems or on electronic cash register systems (of the second party). Both the first party (customer) and second party (merchant) may use the same mobile application (app) or different applications in order to access the system.

In particular, the authentication information is used if the first and the second party meet in the context of a transaction, e. g. at a point-of-sale (POS). The fact that the authentication information received at the first application (and possibly displayed on a display device by the first application) corresponds to the authentication information received at the second application (and possibly displayed on a display device by the second application) proves that the first party has initiated a payment to the second party.

The transfer module may be part of a server system of the service provider or running on a device of the first party (e. g. being integrated to the first application).

Preferably, the system comprises an image store, the authentication module comprises a first submodule for sending a public key assigned to the second party and a reference to a random image in the image store to the first party and a second submodule for receiving a reference encrypted using a public key, decrypting the encrypted reference and displaying an image referenced by the decrypted reference on a display device of the second party.

Accordingly, authenticating the first party vis-a-vis the second party preferably includes the steps of:
sending a public key assigned to the second party and a reference to a random image in an image store to the first party;
encrypting the reference using the public key assigned to the second party;
sending the encrypted reference to the second party;
decrypting the encrypted reference using a private key assigned to the second party; and
comparing an image displayed on a device of the first party, based on the reference received by the first party, and an image displayed on a device of the second party, based on the decrypted reference.

Identifying the first party by a random image is simple and the persons involved on behalf of the first as well as of the second party immediately understand how the authentication works and if authentication is successful or not.

Encrypting the reference using the public key of the second party ensures that third parties are not able to impersonate the sender of the transaction in order to obtain the return service (such as cash and/or goods or services) in lieu of the first party.

Alternatively, the authentication information is represented by machine-readable code (such as 2d or 3d barcode or QR code). This allows for reading the authentication information display on one of the devices of a party using a reading device (such as a barcode reader or camera) of the other party.

Further possibilities of exchanging and comparing the authentication information are available such as based on sound or ultrasound.

Other advantageous embodiments and combinations of features come out from the detailed description below and the totality of the claims.

### BRIEF DESCRIPTION OF THE DRAWINGS

The drawings used to explain the embodiments show:

FIG. 1 A schematic representation of locations of a plurality of parties during a certain time period;

FIG. 2 the representation in FIG. 1, distinguishing between available and non-available information;

FIG. 3 a block diagram of a system suitable for executing the inventive method;

and

FIG. 4 a schematic representation of the flow of information and funds in the context of a method according to the invention.

In the figures, the same components are given the same reference symbols.

### PREFERRED EMBODIMENTS

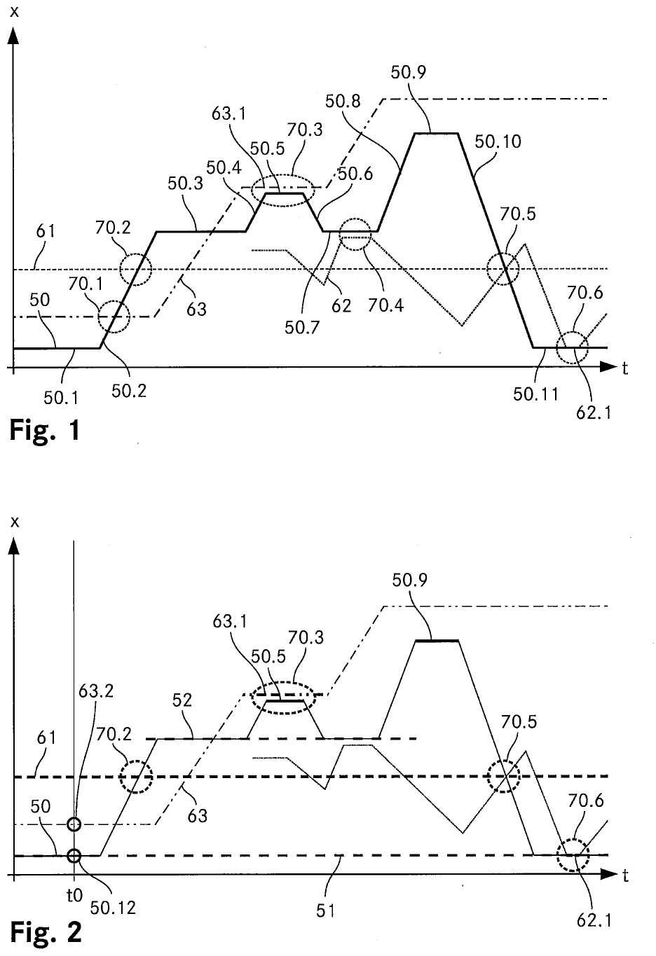

The FIG. 1 shows a schematic representation of locations of a plurality of parties during a certain time period. The horizontal axis (“t”) indicates the time, whereas the vertical axis (“x”) denotes location. It is to be noted that for the sake of simplicity only a single space axis is shown. Furthermore, in a real world application of the inventive method the number of involved candidates for a second party will usually be much higher. The diagram shows the location of a first party (curve 50) as well as of three candidate second parties (curves 61, 62, 63) during a time interval, say 06.00-22.00 of a single day. In the shown example, curve 50 relates to a person that has subscribed to the virtual ATM service. At the beginning of the period, at 06.00, the person is at home (section 50.1), he or she travels to work (section 50.2), is at work (sections 50.3, 50.7), interrupted by a lunch break in a restaurant as well as going to the lunch break and back (sections 50.4, 50.5, 50.6). After work, the person travels to a fitness club (section 50.8), stays at the fitness club for a while (section 50.9), travels home (section 50.10) and spends the evening at home (section 50.11).

Curve 61 relates to a stationary user of the system, e. g. a store offering virtual ATM services. Its location is constant throughout the day.

Curve 62 relates to an employee of a pizza delivery service offering virtual ATM services (as a matter of course other delivery providers such as postal delivery providers etc. may be treated exactly the same way). The curve starts at around noon, because this is when the shift of the employee starts, and before the employee will not be available for virtual ATM services on behalf of his or her employer. The employee delivers a number of orders, schematically illustrated by curve 62. It is relevant for the case described, that one of the deliveries in the evening goes to the first party (section 62.1).

Finally, curve 63 relates to a further individual that has subscribed to the virtual ATM service. There is one interval (section 63.1) where this further individual is close to the first party, e. g. having lunch in the same or a very close restaurant.

In principle this provides several occasions for a transaction between the first party and one of the candidates, indicated by circles and ovals 70.1 . . . 6.

The FIG. 1 shows the complete time-location information with respect to the first party and the three candidates for a second party. However, in reality, the inventive method will usually be based on an incomplete picture. FIG. 2 shows the information that is available in the described example and that may be used in the context of the inventive method:
the location of the home of the first party (line 51);
the location of the place of work of the first party, as well as a probable time interval, the person usually spends at the place of work (line 52);
the place and time of lunch of the first party (section 50.5), e. g. obtained from an entry in a calendar app on the mobile device of the first party;
the location and time of the stay at the fitness center (section 50.9), e. g. obtained from another entry of the calendar app;
the location (and opening hours) of the store (curve 61);
the time of pizza delivery to the home of the first party (section 62.1), e. g. obtained from an order system of the delivery service;
an appointment (location and time interval) of the further individual (section 63.1), e. g. obtained from an entry in a calendar app run on behalf of the further individual;
the current positions 50.12, 63.2 (at the current time t₀) of the mobile subscribers to the ATM service.

Due to the fact that no sufficient location-time information is available, the occasions denoted by circles 70.3, 70.5 are not detected by the inventive method. However, the other occasions (circles or ovals 70.2, 70.3, 70.5, 70.6) may be detected based on the available information, where it is to be noted that the exact time of the first party passing the store at his or her way to the office or way home is not known, but it may be expected that the probability of the first party passing this location is rather big, either based on available movement profiles relating to past activities of the first party or based on a route planner application applied to the location of the home and place of work of the first party.

Accordingly, if the virtual ATM app is invoked by the first person at time t₀ no immediate possibility for a withdrawal will be found as all available candidates are too far away. In contrast, the app will propose a cash withdrawal at one of the following four occasions:
on the way to the place of work, at the store offering virtual ATM services (circle 70.2);
during the lunch break, with the further individual (oval 70.3);
on the way back home, at the store offering virtual ATM services (circle 70.5); or
in the context of pizza delivery (circle 70.6).

If the app is started once more at a later point in time, further occasions may be detected, in particular due to increased information on the activities of the first party and the candidates. Similarly, some occasions detected earlier may be discarded based on the additional information.

Different algorithms may be used for matching a first party desiring to withdraw cash with a suitable second party offering a virtual ATM service.

In a simple case, the known information on time and location is collected similar to what is shown in FIG. 2 (but having two spatial dimensions). Occasions for transfers are identified wherever the trajectory representing the first party crosses a trajectory of a further user offering virtual ATM services or approaches such a trajectory. All the identified occasions may be displayed on the mobile device of the first party, or they may be filtered or ranked as described above.

Another suitable and preferential approach is described in A. Gogna, A. Majumdar: “Blind Compressive Sensing Framework for Collaborative Filtering”, a rXiv:1505.01621 [cs.IR]: The first party is modelled as a vector describing his/her affinity for all the latent factors, and candidate second parties (virtual ATMs) are modelled as vectors defined by the degree to which they possess each of the latent factors in question. The probabilistic model is constructed acknowledging past user affinity data and behavioral models.

The rating matrix is factorized into two matrices, one representing the first party and the other representing the virtual ATMs—both being dense (dense solution promoted by Frobenius norm constraint):

$${min}_{U , V} {‖ Y - A ( UV ) ‖}_{2}^{2} + λ ( {‖ U ‖}_{F}^{2} + {‖ V ‖}_{F}^{2} )$$

where, U and V represent the user and virtual ATM latent factor matrix respectively, λ is the regularization parameter, Y is the available set of ratings and A is a linear operator.

Traditionally two methods Stochastic Gradient Descent (SGD) and Alternating Least Squares (ALS) are commonly employed to solve the above problem. Instead, it is proposed to use a novel algorithm, changing the basic structure of the latent factor model itself while retaining the primary concept that a limited number of (latent) factors affect the overall rating structure. It is proposed to factor the rating matrix into a dense first party latent factor matrix and a sparse virtual ATM factor matrix, by replacing the Frobenius norm constraint on V by a sparsity promoting I constraint.

$${min}_{U , V} {‖ Y - A ( UV ) ‖}_{2}^{2} + {λ}_{u} {‖ U ‖}_{F}^{2} + {λ}_{v} {‖ vec ( V ) ‖}_{1}$$

Traditional formulation suggests that both decomposed matrices are dense, however the proposed algorithm implies that the first party latent factor matrix is indeed dense but the virtual ATM factor matrix is sparse. It is supposed that vectors lie near the range of a generative model G: R^{k}→Rⁿ. Our main theorem is that, if G is L-Lipschitz, then roughly O(k log L) random Gaussian measurements suffice for an I₂/I₂ recovery guarantee. In this manner, it is possible to decompose the rating matrix into a set of dense and sparse matrices, modelling missing values as a k-dimensional vector, recovered using generative models, providing personalized user recommendations.

Further means of detecting opportunities for virtual ATM cash withdrawals exist. As an example, if a user of the system places an order with a company that offers virtual ATM services, a corresponding option may be displayed, and the user may choose that he or she desires to withdraw cash when the order is fulfilled. In the given example, the user might be notified about the virtual ATM service when ordering the pizza, and the cash will be handed over by the delivery person when the pizza is delivered.

Further proposals for cash withdrawal may be based on the user's transaction history, in particular with a financial service provider (such as the user's bank). For this purpose, the provider of the inventive method accesses the transactions relating to a certain time interval before the current day (such as 3 years) and applies machine learning and data analytics in order to predict the user's affinities and preferences as a customer, in particular with respect to shops or service providers.

In order to use the transaction history to match the user to a relevant virtual ATM, the transactions will be preprocessed and categorized along with sorting and dividing sets.

Based on the shop name, the location and external data (e. g. obtained from internet services such as google, googlemaps, directory services etc.) the kind of shop or service provider may be identified. Variables such as “commercial type” (be it a supermarket, shoe store or restaurant), “frequency” (number of times the customer visits a store) and timing (morning, lunch, late afternoon) are determinants which are helpful in suggesting a business offering virtual ATM services to the user. These variables are the basic elements which serve to profile and classify customers. They can be combined as market research mixed variables (frequency and amount for example) in order to maximize the return on data.

Machine learning is applied to this collected and preprocessed data. Basic approaches such as linear regressions, multi-linear regressions and polynomial regressions help to establish the needed patterns in order to create testing and prediction data for further application. As an example, frequency may be mapped against time of purchase in order to obtain a “best place best time aspect”; business type may be mapped against amount spent and frequency (combined metrics) in order to establish a preference; business type may be mapped against time of purchase in order to obtain specific suggestions.

Based on the results, regression functions may be defined, describing the final model and maximizing the compatibility between a user and shops or service providers.

A single layer neural network may be employed, the input layer of which including a user ID, position and time of the day, middle nodes containing weights and biases defined by the aforementioned regression models. The final output will be the “best match” one is looking for.

Once established, the neural network may be further trained based on use cases where the preference of a certain shop or service provider is manifest (supervised learning). In the long term, it would then be possible to simply match the customer and best shops or service providers simply by providing location and time data. The model may be further improved by approaches such as back propagation or multi-layer neural networks.

Using these techniques, each virtual ATM is cross-referenced with the identified pattern to prioritize shops or service providers that match the user's affinities. The ATMs selected based on the transaction history are displayed alongside the ATMs selected based on the other criteria.

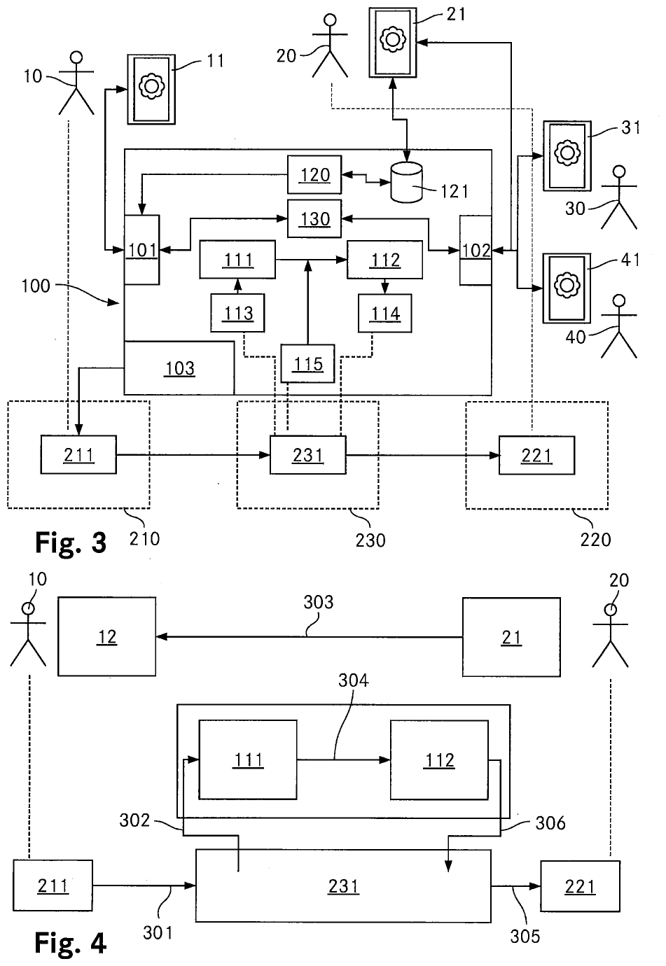

The FIG. 3 shows a block diagram of a system suitable for executing the inventive method. The service provider operating the inventive system is a mobile payment service provider. The system may be used by private persons or businesses.

A customer 10 (first party) operates a mobile device 11 such as a smartphone or tablet. Further users (candidate second parties) 20, 30, 40 operate mobile devices 21, 31, 41 such as smartphones or tablets as well.

All the mobile devices 11, 21, 31, 41 communicate with a server 100 of the mobile payment service provider. For that purpose, the server 100 features application interfaces 101, 102. They are linked with the devices of the customer and merchant respectively by usual means for wide area data communication. In particular they communicate over the internet.

The server 100 further comprises an API interface 103 which allows for accessing an API provided by the customer's bank 210, offering access to functions relating to a bank account 211 of the customer 10. As mentioned above, bank APIs will be required to be opened by banks in the near future under the PSD2 directive. The API access further enables the access to the customer's previous transactions effected by the customer's bank. As described before, these previous transactions may be the basis for virtual ATM suggestions.

The server 100 further comprises a database for the administration of block chain-based e-money accounts. The database stores reference data, whereas the transaction data and further financial data will be stored in a block chain. One of the accounts 111 is assigned to the customer 10, whereas another of the accounts 112 is assigned to one of the further users 20. (Further accounts of users 30, 40 are not shown in the Figure.) The database is accessed inter alia by conversion modules 113, 114 which allow for converting between fiat money stored on a bank account and electronic currency. For that purpose the conversion modules 113, 114 are provided the necessary access to bank accounts as well as to the database. In particular they access a pass-through bank account 231 in the name of the service provider, administrated by a bank 230.

A further bank account 221 of the further user 20 is administrated by bank 220. (Further bank accounts of users 30, 40 are not shown in the Figure.)

The server 100 further comprises a transfer module 115 which allows for transferring electronic currency between the e-money accounts 111, 112 administrated by the server 100 and based on a block chain-based smart contract system.

Furthermore, the server 100 comprises an authentication module 120 as well as an image database 121 that may be accessed by the authentication module 120 as well as over the Internet, by providing a URL pointing to a specific image stored in the image database 121. The authentication module 120 is in data communication with the application interface 101 in order to send information to the mobile device 11 of the customer 10.

Finally, the server 100 comprises a matching module 130 for matching users desiring to withdraw cash (such as customer 10) with a suitable provider of virtual ATM services (such as user 20) using methods as described above.

As mentioned, the e-money accounts 111, 112 are based on a block chain. Private block chains as well as public block chains are available and may be employed in the context of the described system. Private block chains are provided by service providers (such as e. g. Monax Industries) and users require a permission to access the block chain. Public block chains such as Ethereum are publicly available. In both cases storage and management of the block chain data is distributed on a large number of computers.

Natively, usual block chains do not provide anonymous transactions but only pseudo-anonymity: While it is not known which person controls a certain account, all transactions going to or from an account are visible to all nodes in the network. As such, they allow every node in the network to see all transactions which might then in combination with other observations be mapped to an individual user. Thus, when de-anonymizing a single address, the privacy of the funds held at that address and all transactions that this address is involved in are compromised. The observer can directly see in the block chain when the funds were transferred onto that address and when the user is next spending these funds. This allows the observer to monitor the financial assets controlled by the de-anonymized address in both past and future. An observer could for example observe a transaction of a single user standing next to them, e.g. in a shop. By observing 1) the time and 2) volume of the transaction in the shop and searching this transaction in the (potentially public) block chain, the observer might obtain the sender's and recipient's address. Even in a private block chain run by a consortium of banks, a single bank might not want the privacy of their customers get exposed to other banks. Concepts such as zero knowledge proofs or zkSNARKs solve such issues natively and implement them in present or upcoming platforms, such as e. g. Zcash or Hawk. Here, privacy is enhanced utilizing the centralization provided by a bank or financial intermediary as an anonymization tool of the spent funds:

A user will often receive funds which they prefer to keep in their wallet. In order to maintain privacy of these received funds, the user can submit those funds to their bank which credits the funds back to a different address owned by the same user. The receiving user can either inform their bank of the new address to which the funds are to be credited back in encrypted form or perform the same off-block chain (e.g. via Ethereum's Whisper network). For increased privacy, the user can request the transaction coming back from their bank to be 1) broken down into smaller batches and 2) those batches to be sent back over a period of time. In this way, an observer (potentially, a rouge bank in the network) could never infer the ownership of funds by matching incoming and outgoing transactions by amount and time.

Most block chain architectures provide a native token which are issued by the collective network and not just banks or central banks. In Bitcoin and Ethereum for example, the tokens called Bitcoin and Ether respectively, are issued in regular intervals by miners which are enforcing the security and integrity of the network. Also private block chains such as the one provided by Monax Industries, utilize tokens analog to Ether. These native tokens are used to assign (bond) access roles to accounts and prevent spam or DOS attacks.

In order to restrict the issuing ability of funds to banks and financial intermediaries in today's demanding compliance with regulatory requirements, the system relies on a list of registered issuer accounts. These accounts are able to create custom tokens inside the smart contract system as opposed to natively existing tokens such as Ether. As such, every issued token can always be linked to its issuing institution (bank or financial intermediary). The tokens can not only be associated with individual users as outlined in the previous section, but also, as they are issued by an institution for a specific customer, they can be monitored by that institution at all times. The access control of such fund-issuing accounts can be left in the hands of a regulator or national bank. This access control is analogous to granting an existing oversight account of a bank at a central bank's ledger.

Eventually, a user that received tokens might want to encash those tokens at their own bank, which might be different from the issuing bank of the tokens:

| | | | |
|---|---|---|---|
| consumer A: | 10 CHF | to bank A | (fiat transaction) |
| bank A: | 10 vCHF^{A} | to consumer A | (on block chain) |
| consumer A: | 10 vCHF^{A} | to consumer B | (on block chain) |
| consumer B: | 10 vCHF^{A} | to bank B | (on block chain) |

Since each token can be traced back to its issuing institution, the two banks can settle the tokens 1) inside or 2) outside the smart contract environment:
1. Settlement inside the smart contract happens as follows: Bank A receives 10 token from its users that want to cash out tokens that were originally issued by Bank B. Within the same timespan, Bank B receives 10 tokens issue by Bank A. These tokens could be automatically and immediately or on-demand settled inside the block chain. This requires all tokens to be marked by the issuing bank in a secure fashion.
2. Settlement outside the smart contract might be required if only Bank B received 10 tokens which were issued by Bank A. In this scenario settlement could be facilitated by a fiat money transaction of Bank A to Bank B which, upon receiving the funds, will destroy the tokens that were originally issued by Bank A. Below is a representation of such a scenario in which consumer A obtains tokens (vCHF) from their bank in exchange for fiat money which they then transfer to consumer B which is encashing them at their bank B:

| | | | |
|---|---|---|---|
| consumer B: | 10 vCHF^{A} | to bank B | (on block chain) |
| bank B: | 10 CHF | to consumer B | (fiat transaction) |
| bank A: | 10 CHF | to bank B | (fiat transaction) |

| | | |
|---|---|---|
| bank B: | 10 vCHF^{A} | to token-eating black hole contract |

The functioning of the inventive system is described in the following, based on FIGS. 1-4.

In order to use some functionalities of the system, users such as customers and merchants need to register with the system. The characteristics of the registration process depend on the jurisdiction, regulatory requirements, requested payment and withdrawal limits, and requested services. Therefore, different registration options may be offered, presenting different barriers of entry for the user. First, the user obtains and installs the mobile application on his or her mobile device 11, 21, 31, 41 in a matter known as such. Within the application the desired user level is chosen and the required information is provided. In the context of the embodiment of an inventive system and method described below, the following options are offered:
1. No registration: anyone can receive payments on their mobile phone number, email address, or Twitter handle, even if they did not sign up to the system. When a registered user issues a payment to a non-registered phone number, email address or Twitter handle, that recipient will receive information that allows them to sign up to the system (with minimalistic information) and use those funds with all the provided services (including virtual ATM cash withdrawal or payments).
2. Regular registration with bank integration: The user downloads the mobile application of the service in a manner known as such. He or she enters the data which is required by their bank to authenticate them. This may include name, postal address, e-mail address, phone number, date of birth and a valid identification document. This might further include a secret access token or one-time-password that the bank provides via their e-banking system to uniquely identify that user and prevent impersonation by an attacker. This also allows for assigning the bank account 211 of the customer with the system. Alternatively, other payment means may be assigned with the user, such as a PayPal account or a direct debiting scheme.
3. Merchant registration with full information: Merchants who would like to offer the virtual ATM service, will undergo full Know Your Customer identification (including physical verification) and send the required information during first loading of the mobile app. In the context of the registration, the merchant will also provide information with respect to its account for receiving payments in exchange for cash withdrawals. The merchant app will only be activated once complete offline verification has been successfully completed by the service provider. This may include sending an activation code by postal mail to the indicated address of the merchant and asking for input of the activation code in the app run on merchant's device.

As an example, a transaction is described, wherein a customer withdraws cash from another user, offering the services of a “virtual ATM”. The same principles apply to transactions where the inventive system is used for payments in exchange of goods or services or where the “virtual ATM” is not provided by a natural person using a mobile device but by a store or other commercial party.

First of all, the customer 10, already registered with the service, starts the virtual ATM app on his or her mobile device 11 and requests a list of suitable virtual ATMs (possibly already indicating the amount of money that shall be withdrawn). Criteria for building up, filtering or displaying the list may be set by the user in a corresponding “user preferences” section. As an example, the user may choose if the list should be displayed in list or map view. He or she may set a certain duration within which available ATMs are to be shown, the number of ATMs to be shown, etc.

By the corresponding interface 102, the matching module 130 of the server 100 of the mobile payment service provider receives information from all the users 20, 30, 40 of the system offering virtual ATM services. This information includes the present location as well as data on (expected) future locations based on accessible orders, calendar data etc. Further information accessed by the matching module 130 has been extracted from past data. Based on all that information and using the methods described above the matching module 130 generates a list of suitable ATMs and sends this list to the mobile device 11 of the customer 10 using the corresponding interface 101. In addition to the location of the ATMs and a description (including information such as names, photos etc.) a maximum amount for withdrawal may be indicated.

If there is no immediate opportunity to withdraw money from a (nearby) user or if the customer 10 chooses to use a later occasion, he or she may request a reminder if a given location (e. g. a store or restaurant) is reached and/or at a given time. It is also possible to request an automatic alert as soon as the matching module 130 identifies an immediate occasion for cash withdrawal. The corresponding checks are done on the server, and a need for communication with the mobile device 11 of the customer 10 is required only when an occasion is identified.

If there is an immediate opportunity to withdraw money from a (nearby) user 20 and if the customer decides to do the transaction, he or she selects the corresponding virtual ATM and indicates the desired amount of cash. The information is sent to the server 100 and the customer 10 retrieves an asymmetric public key of the ATM of the further user 20 operating the virtual ATM service.

Next, the customer's mobile app retrieves random and unique image URL from the server 100 of the mobile payment service provider, the URL pointing to an image stored on web-accessible image database 121. The URL is generated by the authentication module 120 and sent to the mobile device 11 using the corresponding interface 101.

While the set of images will be of finite size, the URLs should not be re-used for security reasons. Thus the authentication module 120 generates a new URL for each image request and maps this URL to a randomly chosen image.

The customer's mobile app encrypts the image by using the further user's encryption public key. The customer's mobile app then broadcasts the withdrawal request which contains desired amount, currency, target virtual ATM identifier and the encrypted image URL.

Unless the customer already holds sufficient electronic currency in their e-money account 111, the system sends a request to the customer's bank 210 for withdrawing the according amount in fiat money from the customer's bank account 211 and transferring it to the pass-through bank account 231 (step 301). This request is sent via API interface 103. Upon completion of the withdrawal, a corresponding amount of electronic currency is stored onto customer's e-money account 111 (step 302).

The merchant receives a withdrawal request including amount and encrypted image URL, decrypts the URL and the further user verifies that the image, displayed on the display device 23 of the cash desk 21 is matching what the consumer is showing in person on his or her mobile device 11. Due to the encryption of the image URL with the further user's public key, only the further user can view the image but another customer is not able to impersonate the sender of the transaction and steal their physical cash. By using a Diffie-Hellman encryption, both customer and provider of the virtual ATM service are able to decrypt the image URL using their respective encryption keys.

Upon comparing the images, the further user confirms the withdrawal request, hands out the physical cash (step 303) (which may be put into a physical wallet 12 of the customer) and the further user automatically receives the customer's tokens credited to their own e-money account 112 (step 304). Optionally, for enhanced privacy, the further user's mobile app is sending the tokens then to their bank which re-credits these to other addresses controlled by the same user.

The following bank working day, the electronic currency is automatically converted into fiat money, the system transferring the accumulated amounts with respect to a certain user from the pass-through bank account 231 to the bank account 221 of the user (step 305). The corresponding electronic currency on the e-money account 112 is removed from this account (step 306).

If the further user refuses the withdrawal request, the electronic currency stays with the customer. If the customer does not initiate the conversion into fiat money within a certain time limit the fiat money paid by the customer is automatically refunded to the bank account 211 of the customer (or a PayPal account of the customer) and the electronic currency on e-money account 111 is withdrawn.

It is to be noted that the system may deduct fees for incoming, outgoing and/or e-money transactions. This means that the amounts booked on the different accounts do not need to be strictly identical but may differ by amounts corresponding to the deducted fees. Furthermore, the merchant offering the virtual ATM service may be recompensated by receiving a part of the collected fees.

The inventive system and method are not restricted to the embodiment described above. Several aspects may be implemented differently. In particular, the succession of steps may be chosen differently, and the information technology infrastructure may have a different structure.

As mentioned above, instead of the image comparison the verification of the authenticity of the customer may be based on machine-readable code such as visual or acoustic codes.

Instead of a blockchain (or several blockchains), in principle a secured distributed database may be employed.

In summary, it is to be noted that the invention creates a method for effecting financial transactions, wherein a first party obtains cash from a second party that are easy to use and reduce the efforts on the part of the users.

1. Method for effecting financial transactions, wherein a first party obtains cash from a second party, comprising the steps of:
a) determining at least one first time-location pair relating to the first party, based on data accessible by an application running on a mobile device of the first party;
b) determining second time-location pairs relating to a plurality of candidates for the second party;
c) displaying a result of a comparison of the at least one first time-location pair with the second time-location pairs on the mobile device of the first party;
d) choosing one of the plurality of candidates to determine the second party;
e) transferring cash from the second party to the first party.

2. Method as recited in claim 1, wherein the at least one first time-location pair is obtained from a navigation service integrated in the mobile device of the first party.

3. Method as recited in claim 1, wherein the at least one first time-location pair is obtained from a calendar accessible via the mobile device of the first party.

4. Method as recited in claim 1, wherein the at least one time-location pair and/or at least one of the second time location pairs is obtained from an order or reservation accessible by the application running on the mobile device of the first party.

5. Method as recited in claim 1, wherein the at least one time-location pair and at least one of the second time location pairs relates to a future point in time.

6. Method as recited in that claim 1, wherein the mobile device of the first party runs an application being in contact with a server and that a mobile device of the second party runs an application being in contact with the same server.

7. Method as recited in claim 6, wherein the choice of the second party is submitted from the mobile device of the first party to the server and from the server to the mobile device of the second party to generate a message displayed on the mobile device of the second party.

8. Method as recited in claim 1, wherein a user affinity of the first party is compared with recorded properties of the candidates of the second party in order to obtain a rating with respect to the candidates, and in that the result of the comparison displayed on the mobile device of the first party includes the rating.

9. Method as recited in claim 8, wherein a collaborative filtering algorithm is applied to generate a recommendation based on the user affinity and the recorded properties.

10. Method as recited in claim 9, wherein a latent factor model is used for modelling the user affinity and recorded properties.

11. Method as recited in claim 8, wherein the user affinity includes information on past actions and/or preferences of the first party.

12. Method as recited in claim 8, wherein the user affinity of the first party is derived from a history of previous transactions of the first party.

13. Method as recited in claim 12, wherein the history of previous transactions is obtained from a financial service provider of the first party via a software interface.

14. Method as recited in claim 1, wherein transferring the cash from the second party to the first party comprises the following steps:
a) receiving a transaction request from the first party including an identification of the second party and a transaction amount;
b) initiating a first fiat money payment from a bank account of the first party to a pass-through bank account of a service provider;
c) adding an amount of electronic currency corresponding to the fiat money payment to a first e-money account assigned to the first party;
d) authenticating the first party vis-a-vis the second party; and
e) transferring the amount of electronic currency to a second e-money account assigned to the second party.

15. The method as recited in claim 14, wherein the first fiat money payment is initiated by accessing an API of a bank handling the bank account of the first party.

16. The method as recited in claim 14, wherein authenticating the first party vis-a-vis the second party includes the steps of:
sending a public key assigned to the second party and a reference to a random image in an image store to the first party;
encrypting the reference using the public key assigned to the second party;
sending the encrypted reference to the second party;
decrypting the encrypted reference using a private key assigned to the second party;
comparing an image displayed on a device of the first party, based on the reference received by the first party, and an image displayed on a device of the second party, based on the decrypted reference.

17. The method as recited in claim 14, wherein the first and second e-money account are associated with a block chain for the recordal of the e-money transactions.
